(19) United States
(12) Patent Application Publication
(10) Pub. No.: US 2022/0011744 A1
(43) Pub. Date: Jan. 13, 2022

(54) METHOD FOR PROVIDING DATA FOR ADAPTIVE TEMPERATURE REGULATION

(71) Applicant: Siemens Energy Global GmbH & Co. KG, Munich, Bayern (DE)

(72) Inventors: Matthias Goldammer, Munchen (DE); Henning Hanebuth, Pliening OT Gelting (DE); Alexander Sterr, Brunnthal (DE)

(73) Assignee: Siemens Energy Global GmbH & Co. KG, Munich, Bayern (DE)

(21) Appl. No.: 17/294,389

(22) PCT Filed: Oct. 28, 2019
(86) PCT No.: PCT/EP2019/079375

§ 371 Date: May 15, 2021

(30) Foreign Application Priority Data
Nov. 22, 2018 (EP) 18207815.4

(51) Int. Cl. G05B 19/4099; G05B 19/4155

(52) U.S. Cl. CPC G05B 19/4099; G05B 2219/49023; G05B 2219/50333; G05B 19/4155

(57) ABSTRACT

A method, device, and computer program product for providing data for temperature regulation in the additive manufacture of a component, where the method includes a) acquiring temperature data at various positions of a layer built up additively; b) processing the layer for the component using a processing device at the positions of the layer, wherein regulation data for regulating the processing device is acquired depending on a position; and c) generating an adapted data set from the acquired data comprising position-dependent adapted regulation data.

### CROSS REFERENCE TO RELATED APPLICATIONS

This application is the US National Stage of International Application No. PCT/EP2019/079375 filed 28 Oct. 2019, and claims the benefit thereof. The International Application claims the benefit of European Application No. EP18207815 filed 22 Nov. 2018. All of the applications are incorporated by reference herein in their entirety.

### FIELD OF INVENTION

The present invention relates to a method for providing data for temperature regulation, in particular adaptive temperature regulation, in the additive manufacturing of a component, such as powder-bed-based manufacturing. An apparatus, a computer program product and a method for the additive manufacturing of the component, which uses the data provided, are also specified.

The component may be intended for use in a turbomachine, in particular in the hot gas path of a gas turbine. The component may consist of a superalloy, in particular a nickel-based or cobalt-based superalloy. The alloy can be, for example, precipitation hardened or solid solution hardened.

### BACKGROUND OF INVENTION

In gas turbines, thermal energy and/or flow energy of a hot gas generated by burning a fuel, for example a gas, is converted into kinetic energy (rotational energy) of a rotor. For this purpose, a flow channel is formed in the gas turbine, in whose axial direction the rotor or a shaft is mounted.

The turbine blades expediently project into the flow channel. If a hot gas flows through the flow channel, a force is applied to the rotor blades and is converted into a torque which acts on the shaft and drives the turbine rotor, wherein the rotational energy can be used, for example, to operate a generator.

Modern gas turbines are the subject of constant improvement in order to increase their efficiency. However, this leads, among other things, to ever higher temperatures in the hot gas path. The metallic materials for rotor blades, especially in the first stages, are constantly being improved with regard to their strength at high temperatures (creep load, thermomechanical fatigue).

Due to its disruptive potential for the industry, generative or additive manufacturing is also becoming increasingly interesting for the series production of the above-mentioned turbine components, for example turbine blades or burner components.

Additive manufacturing methods include, for example, as powder bed methods, selective laser melting (SLM) or laser sintering (SLS), or electron beam melting (EBM).

A method for selective laser melting is known, for example, from EP 2 601 006 B1.

Additive manufacturing methods have also proven to be particularly advantageous for complex components or components of complicated or filigree design, for example labyrinth-like structures, cooling structures and/or lightweight structures. In particular, additive manufacturing is advantageous due to a particularly short chain of process steps, since a production or manufacturing step of a component can take place almost exclusively on the basis of a corresponding CAD file and the selection of appropriate manufacturing parameters.

The term “computer program product” described herein can represent or include a computer program means, for example, and can be provided or included, for example, as a storage medium, for example a memory card, a USB stick, a CD-ROM, a DVD, or else in the form of a downloadable file from a server in a network. This may take place, for example, in a wireless communication network through the transmission of an appropriate file comprising the computer program product or the computer program means.

An ubiquitous problem with additive manufacturing methods for highly stressed or highly stressable components are the structural properties or material properties which are often inferior to conventional manufacturing techniques. In order to achieve better material properties in additive manufacturing, a further heat source can be used in addition to the laser to better control the heating and cooling behavior. When processing metals, especially superalloys, induction heating systems are suitable for this purpose, but, due to the uneven application of the heating power, additionally require mechanical positioning of the induction coil(s).

The heating power must likewise be controlled, since the geometry has a very strong influence on the heating or the coupling efficiency or effect of the heating. For temperature regulation and/or capture, it is possible to use an infrared camera which overlooks the entire construction site (of an AM system). The image information can be converted into a temperature via calibration and can be evaluated, for example, at the position of the coils. It is possible that only a fixed position (“region of interest”) within the image is evaluated here and can then be shifted in the image with the coil. This temperature can also be transferred to a regulator or a regulation device with fixed parameters. After a position shift, for example in order to heat a further region of a layer which has been constructed or is to be constructed during the manufacturing of the component, the coil typically reaches another (cold) point and regulates the heating power again.

The image from the infrared camera can be evaluated within the region of interest, and an actual value can thus be generated for the temperature regulation and is used for regulation.

The problem, however, is that the induction depends greatly on the geometry of the metal part to be heated or a layer that has just been constructed. A current or eddy current preferably flows in this case in the structure that has already been constructed directly under the heating device or coil and requires a closed electrical circuit in order to achieve high currents and thus a good heating result. This circuit can be closed laterally outside the area of influence of a heating device or coil, for example by means of opposite coil parts or via a structure (component) which has already been constructed. If there is no closed circuit, the coupling efficiency drops drastically, for example with very small structures or in a loose powder bed. Owing to the small particle size, usually in the range between 10 and 100 μm in diameter, the powder itself is hardly heated and the heating or its efficiency is mainly determined by the geometry of a previously constructed layer. It is therefore necessary to improve the coupling efficiency or heating efficiency, in particular in the case of powder-bed-based additive methods for high-performance components.

### SUMMARY OF INVENTION

It is therefore an object of the present invention to specify means which can be used to achieve the heating efficiency or an improvement in the coupling efficiency, as described.

This object is achieved by means of the subject matter of the independent patent claims. The dependent patent claims relate to advantageous configurations.

One aspect of the present invention relates to a method for providing data for temperature regulation in the additive manufacturing of a component. The method is advantageously part of regulation optimization for temperature control or heat management in powder-bed-based additive manufacturing.

The method comprises capturing temperature data or temperature information in each case at different or (pre)determined positions (“region of interest”) of an additively constructed layer. This layer mentioned can denote one of several hundred or thousand layers which are additively constructed one after the other via powder bed processes by selective irradiation with a laser or energy beam.

The method also comprises processing the layer for the component with a processing device, in particular a movable processing device, at the positions of the layer, wherein regulation data, for example for or comprising a control parameter, for regulating the processing device are captured in a position-dependent manner.

The term “position-dependent” can denote a location dependency, for example in XY coordinates, on the layer or on a corresponding manufacturing surface.

The method also comprises generating or determining an adapted or optimized data record from the captured data comprising position-dependent adapted regulation data. The generation or determination can take place, for example, via manual, machine or automated regulator optimization or other means.

For the regulation, it is possible to use, for example, a PID regulator which can usually be set more sharply when slowly approaching a setpoint value and rather more conservatively when it comes to so-called “overshoots”.

Improved regulation, for example for a material layer to be subsequently constructed, can advantageously be achieved by providing the adapted data record, in particular the adapted regulation data. It is particularly advantageous in this case that, instead of using a single set of regulation parameters for any geometries (prior art), it is now possible to provide and use position-dependent and/or individual regulation parameters which take into account the actual and exact geometry of the individual layers for the component.

At the same time, the risk of overheating due to overshoots in the regulation or in the temperature profile can be avoided. Without the means presented, this would only be possible, for example, by virtue of very conservative setting or regulation and corresponding extension of the construction or process time.

Furthermore, the process or construction time, which is the main efficiency-limiting factor for industrial additive manufacturing processes, can be reduced to a minimum. The adaptive regulation, which is made possible by the modified or adapted data or regulation parameters, can advantageously already be used for individual components or, for example, for the first component of a production series. A previous calculation or even only previous knowledge of the geometry of the component is not necessary. In addition, the system can be implemented independently of the laser control and therefore can be implemented substantially more easily and more robustly. Heat conduction during the process as well as coupling efficiency, for example of electrical power into the system, can also be taken into account.

In one configuration, a further layer following the above-mentioned layer, for example during the manufacturing of the component, is processed by the processing device (see below) according to the adapted regulation data.

In one configuration, the regulation data denote data or information or parameters of or for a PID regulator. Alternatively, the regulation data can be corresponding information for a PI regulator or a PD regulator or another regulator or another regulation device.

In one configuration, the adaptive data record comprises only the adapted regulation data. According to this configuration, the advantages according to the invention can already be used and the regulation can be improved accordingly. At the same time, the effort for generating or providing the adapted data record can be minimized.

In one configuration, the adaptive data record comprises temperature data and/or further data or information, for example, in addition to the adapted regulation data. According to this configuration, the accuracy and thus the regulation result can be additionally improved, for example by collecting and processing further temperature data or by taking the geometry of the component into account again in layers.

In one configuration, the regulation data comprise a control parameter or regulate the latter, wherein the control parameter is suitable—for the processing of the layer by the processing device—for controlling a heating power for preheating a layer during the additive construction of the component.

The term “during” in connection with the additive manufacturing of the component is intended to mean in the present case that, for example, a layer is processed overall during the manufacturing of the component, but is advantageously processed by the processing apparatus (in layers) after the respective solidification of the layer.

In one configuration, the regulation data to be captured for each position on the layer are captured and/or stored over a predetermined course of time. Ideally, the current regulation data or information, for example for the integration and differentiation of the regulator, are also stored.

In one configuration, the adapted data record, in particular the adapted regulation parameters or regulation data, is/are generated by means of machine optimization methods, for example comprising artificial neural networks or genetic or evolutionary algorithms.

In one configuration, the method is a computer-implemented method.

In one configuration, the method is a recursive method which is used again, repeatedly or again and again for successive layers for the component, for example during the (additive) manufacturing of the component. According to this configuration, the regulation and thus the process efficiency as well as the heat management for the component can be additionally improved.

In one configuration, the method is used to preheat layers made of superalloys, in particular nickel-based or cobalt-based superalloys, during the manufacturing of high-performance components, in particular hot gas turbine parts.

A further aspect of the present application relates to an apparatus or a system for controlling an expediently movable processing device, in particular an inductive heating device, comprising means for carrying out the described method. These means can be a computer program, a computer program product, a data structure product or other corresponding computer program means.

The apparatus also comprises a temperature capture device, a computer or a data processing device and a regulation device, advantageously a PID regulator.

In one configuration, the temperature capture device comprises an infrared camera. According to this configuration, a temperature image of an additively constructed layer can be determined in a particularly simple and expedient manner and temperature data can be captured particularly easily and quickly.

In one configuration, the processing device comprises an inductive heating device.

In one configuration, the processing device is an inductive heating device.

In one configuration, the apparatus is configured in such a manner that the temperature capture device, the computer, the regulation device and an inductive heating device coupled to the apparatus form a measurement system or a regulation chain together with a structure of at least one already constructed layer of the component, for example a previously constructed layer. This measurement system, which thus concomitantly includes a part of the component, can advantageously be used to take into account, control and/or improve the efficiency with which, for example, energy is introduced into the measurement system by the processing device and the component is thus heated (coupling efficiency). In other words, the effect of the processing device, in particular the heating device, on the structure of the component can be improved.

If only a small cross-sectional area of a structure needs to be constructed in the layer currently to be constructed, the possibility of introducing heat into the component and also dissipating it again is limited by the fact that pulverulent base material is thermally quasi-insulating for the component. The measurement system provided can in particular enable fast, stable and/or precise regulation of the temperature of the component and correspondingly effective (inductive) heating of the component.

In one configuration, the apparatus is part of an additive manufacturing system, in particular a system for powder-bed-based additive manufacturing.

A further aspect of the present invention relates to a computer program product comprising instructions which, when the program is executed by a computer, cause the computer to generate the adapted data record, as described above. The computer program product can for example comprise corresponding computer program means which are required to accordingly generate or provide the adapted data record.

A further aspect of the present invention relates to a computer-readable medium on which the above-mentioned computer program or computer program product is stored.

A further aspect of the present invention relates to a method for the additive manufacturing of the component, comprising the layer-by-layer additive construction of the component from a powder or pulverulent base material, wherein, after or during the solidification or construction of a powder layer by means of an energy beam, in particular a laser, this layer is processed by means of the processing device on the basis of the adapted data record provided as described above or corresponding regulation or control parameters. The improved regulation parameters in the adapted data record can therefore have a direct influence on the subsequent manufacturing method, since the heat processing of the component can be decisively improved on the basis of the adapted data and thus improved material or structural properties can also be achieved.

Another aspect of the present invention relates to a component which is manufactured or can be manufactured according to the method for additive manufacturing. For example, in contrast to a conventionally manufactured component from the prior art or an additively manufactured component from the prior art, the component comprises a largely crack-free and/or low-stress, in particular monocrystalline and/or columnar crystalline, microstructure.

The means described in the present case are advantageously suitable for heating a processing or preheating of the component or a component layer to be subsequently manufactured to a temperature of over 1000° C.

Configurations, features and/or advantages which in the present case relate to the method for providing data, the computer program product or the apparatus can—as explained—also relate to the additive manufacturing process or the component itself, or vice versa.

Further features, properties and advantages of the present invention are explained in more detail below on the basis of exemplary embodiments with reference to the accompanying figures. All of the features described so far and below are advantageous both individually and in combination with one another. It goes without saying that other embodiments can be used and structural or logical changes can be made without departing from the scope of protection of the present invention. The following description therefore should not to be interpreted in a restrictive sense.

The term “and/or” used here, when used in a series of two or more elements, means that any of the listed elements can be used alone, or any combination of two or more of the listed elements can be used.

### BRIEF DESCRIPTION OF THE DRAWINGS

FIG. 1 shows a schematic sectional view of a component during its additive manufacturing.

FIG. 2 shows a schematic plan view of a component cross section which is processed with a processing device.

FIG. 3 uses a schematic plan view of a solidified component layer to indicate a sequence of a plurality of processing steps.

FIG. 4 shows a schematic flowchart which indicates method steps of the method described.

### DETAILED DESCRIPTION OF INVENTION

In the exemplary embodiments and figures, identical or identically acting elements can each be provided with the same reference signs. The elements shown and their proportions to one another are fundamentally not to be regarded as true to scale; rather, individual elements can be shown exaggeratedly thick or with large dimensions for better presentability and/or for better understanding.

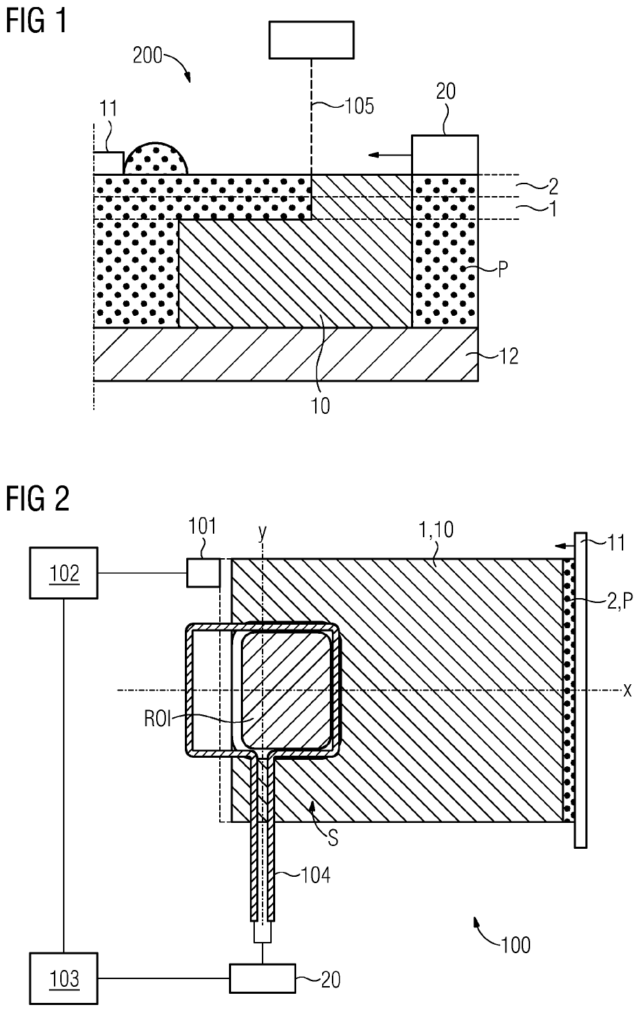

FIG. 1 uses a schematic sectional view to indicate the additive manufacturing of a component 10 from a powder bed, advantageously by means of selective laser melting or electron beam melting. A corresponding additive manufacturing system is identified with the reference sign 200.

A starting material P for the component 10 is selectively irradiated in layers by an energy beam, advantageously a laser beam 105, in accordance with the desired (predetermined) geometry. For this purpose, the component is manufactured on a substrate or a construction platform 12 or welded to it.

The platform simultaneously serves as a mechanical support during manufacturing in order to protect the component from thermal distortion. After the solidification of each layer, a manufacturing surface (not explicitly identified) is newly coated with powder P, advantageously by a coater 11, and the component is constructed further in this way. Layers 1 and 2 are indicated by dashed lines in FIG. 1 merely by way of example, the layer thickness of which in such processes is usually between 20 and 80 μm.

The component 10 is advantageously a component which is used in the hot gas path of a turbomachine, for example a gas turbine. In particular, the component can be a rotor or guide blade, a segment or ring segment, a burner part or a burner tip, a frame, a shield, a heat shield, a nozzle, a seal, a filter, an orifice or lance, a resonator, a stamp or an agitator, or a corresponding transition, insert, or a corresponding retrofit part. Accordingly, the component 10 is advantageously a component that is thermally and/or mechanically highly stressed in its intended operation and is made of a superalloy, for example a cobalt-based or nickel-based superalloy.

A processing device 20 is also indicated on the right-hand side of a manufacturing surface (on the right in the figure). The processing device can be used to expediently pretreat and/or post-treat a newly applied powder layer or a freshly solidified or irradiated component layer. This processing is particularly advantageous or expedient in order to carry out an advantageous or necessary heat treatment (heat management) of the corresponding components, advantageously in-situ during construction.

The large process-inherent temperature gradients in powder-bed-based processes often exceed 10⁵ K/s and accordingly cause high chemical imbalances, cracks and/or mechanical stresses. It is therefore expedient, for example, to thermally treat a newly applied powder layer (see reference sign 2) or an already solidified component layer (see reference sign 1) with a processing device (see reference sign 20).

The means described in the present case for the processing or the processing device 20 are advantageously suitable for heating a processing or preheating of the component or a component layer to be subsequently manufactured to a temperature of over 1000° C.

FIG. 2 shows a schematic plan view of a layer 1 freshly irradiated with the energy beam 105 and solidified. As in FIG. 1, a coater 11 or a coating device can be seen here, which is configured to apply new powder P for a layer to be subsequently irradiated (see reference sign 2 in FIG. 1).

According to the illustration in FIG. 2, the cross section of the component 10 is only shown in a rectangular shape for the sake of clarity. In the case of components for which additive manufacturing is offered or worthwhile, this is of course often not the case, and the component cross section can have a complicated geometry, for example a geometry which is not closed or has cavities.

In contrast to FIG. 1, according to the present invention, it is possible to see a processing device 20 which advantageously comprises or represents an inductive heating device. Alternatively, the processing device can introduce heat into a component layer using a different principle, for example.

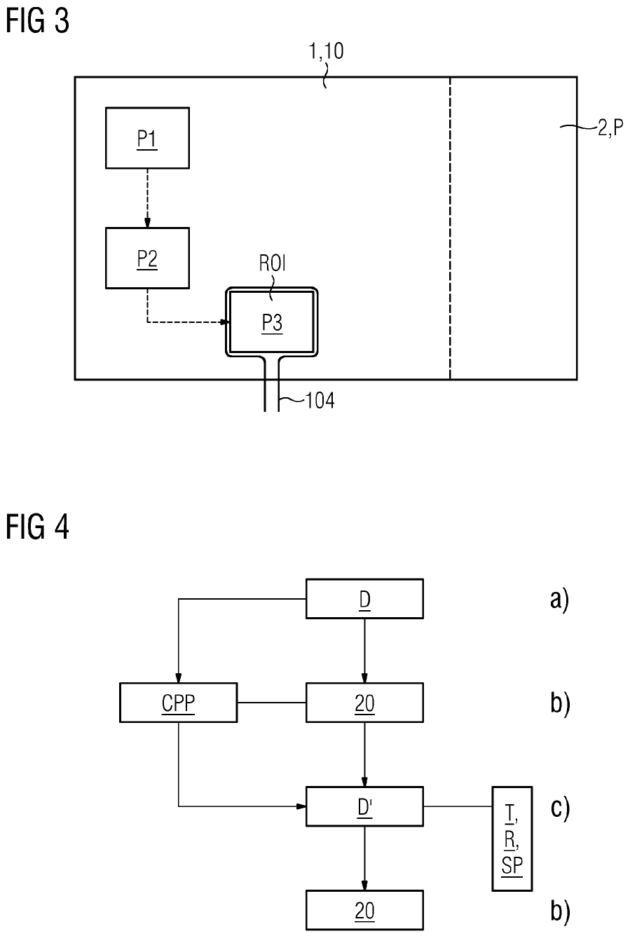

A conventional additive manufacturing system (see reference sign 200 in FIG. 1) advantageously comprises a temperature capture device 101, advantageously an infrared camera, which can be used to record, advantageously for each irradiated layer, a complete temperature image of the layer or of the manufacturing surface. An item of image information from the temperature image can, for example, be converted into a temperature via calibration and can be evaluated at corresponding positions of later processing (see FIG. 3 further below).

Via a computer 102 or a data processing device and advantageously also a regulation device 103, captured temperature data, advantageously said temperature or the thermal image of the layer 1, can be stored and transferred to the processing device 20 or this can be controlled accordingly.

An apparatus 100 can accordingly be configured to control the processing device 20 and can also comprise said computer program means (see reference sign CPP further below), the temperature capture device 101, the computer 102 and, for example, the regulation device 103. Accordingly, the apparatus 100 can be coupled or connected to the processing device 20.

In the embodiment shown in FIG. 2, the processing device 20 has an inductive heating device or an induction coil 104. Although this is not explicitly shown, the device 20 can also have a plurality of induction coils, for example a coil arranged displaceably or movably along the X direction and a coil arranged displaceably or movably along the Y direction. The coils mentioned can also be superimposed in such a way that desired or predefined heating, for example heating of over 1000° C., can be achieved only in a selected region (cf. “region of interest” and reference sign ROI). For the sake of simplicity, only one coil 104, which can heat a region ROI to be selected in a predefined manner, is identified in FIG. 2. The coil 104 is arranged to be movable and displaceable along the X direction. In the same way, a similar coil could be movable along the Y direction and arranged in such a way that the selected region ROI can be expediently heated.

The processing device 20 is also advantageously configured, through its movability, over any positions above the powder bed or the layer surface that both an already solidified component layer (see layer 1) and a layer of newly applied powder material (see layer 2) can be heated. In contrast to the solid component structure, however, heating of the powder (see on the left in FIG. 2) is negligible, and the heating power is dominated or absorbed by the already solidified layers at the bottom. In the SLM method, these layers are generally significantly thinner than the penetration depth of the induction field or the magnetic flux of the coil(s) 104 that induces the eddy currents.

The apparatus 100 is advantageously also configured in such a manner that the temperature capture device 101, the computer 102, the regulation device 103 and an inductive heating device 20, 104 coupled to the apparatus 100 form a measurement system S or a corresponding regulation chain together with a structure of at least one constructed layer 1 of the component 10. This system or this regulation chain is composed of the temperature capture device 101, the computer 102 and the aforementioned computer program means, the device 20 or the induction coil 104 and the structure of the component 10 itself, or comprises these components.

For example, with each recorded camera or temperature image, the measurement system S transfers an actual temperature for each selected region ROI to the regulation device 103 which comprises a PID regulator, for example.

The component 1, 10 itself or the point currently to be heated or preheated can influence the regulation in two ways in this case: On the one hand, the coupling efficiency and thus the effect of the induction heating on the component 10 can change. On the other hand, the limited heat conduction can lead to a delay between heating and temperature change. Both variables or values are greatly dependent on the actual geometry and are usually unknown to the regulation system. Even if the geometry is exactly known, the values can only be determined by complete simulation of the electrical and thermal behavior that adequately describes the phenomena described.

The present invention now proposes means for optimizing and improving the regulation system in such a way that the simulations mentioned can be dispensed with, and for deriving adapted data or regulation parameters from the system itself (see FIGS. 3 and 4 further below).

FIG. 3 shows, on the basis of a representation similar to the representation in FIG. 2, a sequence of processing steps, on the basis of which a solidified component layer 1 is processed, advantageously inductively heated, advantageously immediately, after solidification by means of the processing device 20 described.

For example, a heat treatment tailored to the alloy of the component may be necessary or advantageous, for example, in order to relieve tension in the component, avoid or prevent hot cracks or to prevent large process-inherent temperature gradients which in turn prevent cracks, chemical imbalances or, in principle, weldability of the base material.

The corresponding processing regions (compare ROI at positions P1, P2 and P3 in FIG. 3) can be, for example, those positions which are also irradiated one after the other according to an irradiation strategy. Alternatively, they may be specially selected regions, for example regions in the layer which are particularly susceptible to structural defects or other factors, for example strength-related factors. The positions can also—unlike in FIG. 3—merge continuously or steadily into one another.

Typically, after processing a first position P1, the coil 104 or the processing device 20 is moved to a subsequent second position P2 or third position P3, which then indicates a not yet heated or cold point and can be processed, for example, in a corresponding ROI of the position. Instead of three positions and ROIs, as indicated in FIG. 3, in reality, for example, several hundred positions can be approached and processed per layer.

According to the present invention, the temperature data, as described above, are stored and/or captured at different positions of the additively constructed layer 1 (see method step a) further below). Furthermore, according to the invention, during the processing of the layer, for example along the positions P1 to P3, regulation data, for example comprising control parameters for the processing device, are stored and/or captured in a position-dependent manner and for each position (P1 to P3) (see method steps b) in FIG. 4 further below). Furthermore, according to the method described (see method steps c) in FIG. 4 further below), an adapted or optimized data record D′ is generated or provided from the captured data comprising regulation data R′ (see below) that are adapted in a position-dependent manner.

According to the method described, only the adapted regulation data, for example regulation data and a control parameter for a PID regulator as regulation device 103, or temperature data in addition to the adapted regulation data can be included in the adapted data record.

In the context of the described method, the regulation data to be captured can be captured and/or stored, for example, for each position on the layer again over a predetermined course of time (not explicitly identified in the figures). Ideally, the current internal values for the integration and differentiation (in the case of a PID regulator) are also stored.

Within the scope of the described invention, provision is made for the adapted data record to comprise, for example, by means of machine optimization methods, for example representing or comprising artificial neural networks or genetic or evolutionary algorithms. Alternatively, other optimization methods can be used to provide the adapted data record.

The described method, in particular the provision of the adapted data record, can furthermore be a recursive method, for example a method which is used again or iteratively for successive layers during the additive manufacturing of the component 10, for example in order to get better and better adapted values for each layer for the regulation parameters, and thus to optimize the temperature regulation and the process efficiency even further.

In a simple embodiment, it is not necessary to record the values for a complete layer or the complete component. The new or adapted parameters for the last processed position are then determined directly after heating and only the PID values (regulation parameters) for the next layer, for example layer 2, are stored.

In the case of small batches or large batches, it can be advantageous, for example in industrialized additive manufacturing, to store the determined parameters completely for all layers. Since the parameters determined actually apply to the current layer and not to the next one, the correct values can already be used in the current layer from the second component on, for example.

FIG. 4 summarizes method steps according to the invention using a schematic flowchart and indicates that the method described is a computer-implemented method, for example a method in which a computer program product or a corresponding computer program generates the adapted data record.

The method is a method for providing data D for temperature regulation in the additive manufacturing of the component 10. The method comprises a) capturing temperature data T in each case at different positions P1, P2 of an additively constructed layer 1.

The captured data D can be, for example, initial regulation data R, a control parameter SP, temperature data T or information relating to the captured temperature image (see above).

The method also comprises b) processing the layer 1 for the component 10 with a processing device 20 at the positions P of the layer 1, wherein regulation data R for regulating the processing device are captured in a position-dependent manner.

The method also comprises c) generating an adapted data record D′ from the captured data. In addition to the position-dependent, adapted regulation data R′, the adapted data record can, for example, comprise temperature data T or, for example, a control parameter SP for controlling or regulating the processing device 20. In particular, this method step can be implemented by means of a computer program or a corresponding computer program product CPP.

The invention is not restricted by the description based on the exemplary embodiments to these exemplary embodiments, but rather encompasses any new feature and any combination of features. This includes in particular any combination of features in the patent claims, even if this feature or this combination itself is not explicitly specified in the patent claims or exemplary embodiments.

1. A method for providing data for temperature regulation in the additive manufacturing of a component, comprising:
a) capturing temperature data in each case at different positions of an additively constructed layer,
b) processing the layer for the component with a processing device at the positions of the layer, wherein regulation data for regulating the processing device are captured in a position-dependent manner, wherein the regulation data denote data or parameters of or for a PID regulator, wherein the regulation data include or regulate a control parameter which is suitable for controlling, for the processing, a heating power for preheating a layer during the construction of the component, and
c) generating an adapted data record from the captured data comprising position-dependent adapted regulation data.

2. The method as claimed in claim 1,
wherein a further layer following the layer during the manufacturing of the component is processed according to the adapted regulation data.

3. The method as claimed in claim 1,
wherein the adapted data record comprises only the adapted regulation data.

4. The method as claimed in claim 1,
wherein the adapted data record comprises temperature data in addition to the adapted regulation data.

5. The method as claimed in claim 1,
wherein the regulation data to be captured for each position on the layer are captured and/or stored over a predetermined course of time.

6. The method as claimed in claim 1,
wherein the adapted data record is generated by machine optimization methods.

7. The method as claimed in claim 1,
which is a computer-implemented method.

8. The method as claimed in claim 1,
which is a recursive method which is used again for successive layers during the manufacturing of the component.

9. An apparatus for controlling a processing device, comprising:
means for carrying out the steps of the method as claimed in claim 1,
a temperature capture device,
a computer, and
a regulation device.

10. The apparatus as claimed in claim 9,
which is configured in such a manner that the temperature capture device, the computer, the regulation device and an inductive heating device coupled to the apparatus form a measurement system together with a structure of at least one constructed layer of the component.

11. The apparatus as claimed in claim 9,
which is part of an additive manufacturing system.

12. A non-transitory computer readable media, comprising:
instructions which, when executed by a computer, cause the computer to perform the method as claimed in claim 1.

13. A method for the additive manufacturing of a component, comprising:
layer-by-layer additive construction of the component from a powder,
wherein, after or during the solidification of a powder layer by means of an energy beam, this layer is processed by means of the processing device on the basis of the method as claimed in claim 1.

14. The apparatus as claimed in claim 9,
wherein the apparatus comprises an inductive heating device.

15. The apparatus as claimed in claim 11,
wherein the additive manufacturing system comprises a system for powder-bed-based additive manufacturing.
